(19) United States
(12) Patent Application Publication
(10) Pub. No.: US 2017/0223768 A1
(43) Pub. Date: Aug. 3, 2017

(54) DYNAMIC ADJUSTMENT OF TRANSMISSION TIMEOUT INTERVAL IN COMMUNICATION PROTOCOLS

(71) Applicant: QUALCOMM Incorporated, San Diego, CA (US)

(72) Inventors: Amit JAIN, San Diego, CA (US); Govind Ram VENKAT NARAYAN, San Diego, CA (US); Srigouri KAMARSU, Cupertino, CA (US); Dinesh SUBRAMANI, San Diego, CA (US)

(21) Appl. No.: 15/011,758

(22) Filed: Feb. 1, 2016

(51) Int. Cl. H04W 76/06

(52) U.S. Cl. CPC H04W 76/068

(57) ABSTRACT

Disclosed are methods, devices, systems, apparatus, servers, computer-/processor-readable media, and other implementations, including a method, performed at a first processor-based wireless device, that includes transmitting at a first time instance, from the first wireless device to a second wireless device, a wireless message including message content, and dynamically determining an adjustable timeout interval based, at least in part, on one or more network characteristics associated with a network comprising the first and/or second wireless devices. The method further includes transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

### BACKGROUND

Wireless devices frequently communicate with each other via multi-message exchange communication protocols. For example, in some embodiments, LPP protocol messages are used to transport location specific information via non-access stratum (NAS) protocol data unit (PDU) messages. If there are network problems, messages, of the message exchange, may get dropped, but may get re-transmitted. In some embodiments, failure to complete an exchange within some pre-determined time period (e.g., transmitting or retransmitting a request, and receiving an acknowledgement in response thereto) may cause communication session failure (e.g., LPP session failure).

### SUMMARY

In some variations, an example method is provided that includes, at a first processor-based wireless device, transmitting at a first time instance, from the first wireless device to a second wireless device, a wireless message including message content, and dynamically determining an adjustable timeout interval based, at least in part, on one or more network characteristics associated with a network comprising the first wireless device, the second wireless device, or both the first wireless device and the second wireless device. The example method further includes transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

In some variations, an example wireless device is provided that includes one or more processors configured to dynamically determine an adjustable timeout interval based, at least in part, on one or more network characteristics associated with a network comprising the example wireless device, another wireless device, or both the example wireless device and the other wireless device. The example wireless device further includes at least one transceiver, coupled to the one or more processors, configured to transmit at a first time instance, from the example wireless device to the other wireless device, a wireless message including message content, and transmit at least one subsequent wireless message including at least some of the message content of the wireless message upon a determination that an acknowledgement message responsive to the wireless message transmitted at the first time instance was not received at the example wireless device within a time period, subsequent to the first time instance, greater or equal to the determined adjustable timeout interval.

In some variations, an example apparatus is provided that includes means for transmitting at a first time instance, from a first wireless device to a second wireless device, a wireless message including message content, and means for dynamically determining an adjustable timeout interval based, at least in part, on one or more network characteristics associated with a network comprising the first wireless device, the second wireless device, or both the first wireless device and the second wireless device. The example apparatus further includes means for transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

In some variations, example non-transitory computer readable media are provided. The example computer readable media are programmed with instructions, executable on a processor, to transmit at a first time instance, from a first wireless device to a second wireless device, a wireless message including message content, and dynamically determine an adjustable timeout interval based, at least in part, on one or more network characteristics associated with a network comprising the first wireless device, the second wireless device, or both the first wireless device and the second wireless device. The example computer readable media are also programmed with further instructions to transmit at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

Other and further objects, features, aspects, and advantages of the present disclosure will become better understood with the following detailed description of the accompanying drawings.

### BRIEF DESCRIPTION OF THE DRAWINGS

FIG. 1 is a schematic diagram of an example operating environment that includes a mobile wireless device in communication with one or more wireless devices, in accordance with certain example implementations.

FIG. 2 is a flowchart of an example procedure to dynamically determine an adjustable timeout interval for transmitting subsequent wireless messages from a first device to a second device, in accordance with certain example implementations.

FIG. 3 is a diagram of an example wireless message flow exchange between a first device and a second device, in accordance with certain example implementations.

FIG. 4 is a schematic diagram of an example wireless device (e.g., a mobile wireless device), in accordance with certain example implementations.

FIG. 5 is a schematic diagram of an example node (e.g., an access point), in accordance with certain example implementations.

FIG. 6 is a schematic diagram of an example computing system, in accordance with certain example implementations.

Like reference symbols in the various drawings indicate like elements, in accordance with certain example implementations.

### DETAILED DESCRIPTION

Described herein are methods, systems, devices, computer readable media, and other implementations, for dynamically managing message transmission (e.g., transmission/retransmission of subsequent wireless messages that have similar or same content as an earlier unacknowledged wireless message) in a communication protocol. Example embodiments include a method including, at a first processor-based wireless device, transmitting at a first time instance, from the first wireless device to a second wireless device, a wireless message including message content, dynamically determining an adjustable timeout interval based, at least in part, on one or more network characteristics associated with a network comprising the first wireless device, the second wireless device, or both the first wireless device and the second wireless device, and transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval. In some embodiments, the wireless message may include a long-term evolution positioning protocol (LPP) message. In some embodiments, determining the adjustable timeout interval may include determining subsequent time instances at which the at least one subsequent wireless message, which may have the same or similar content as the wireless message transmitted at the first time instance, is to be transmitted, with the subsequent time instances determined based, for example, on time remaining before a current session between the first wireless device and the second wireless device is concluded. Thus, for example, if a current session (e.g., an LPP session) is about to expire, the adjustable timeout interval may be shortened so that transmission of a subsequent wireless message, and possibly several subsequent transmissions of subsequent wireless messages with content similar to that included in the original wireless message (i.e., effectively re-transmission of the original wireless message), if necessary, can be performed before the current session expires.

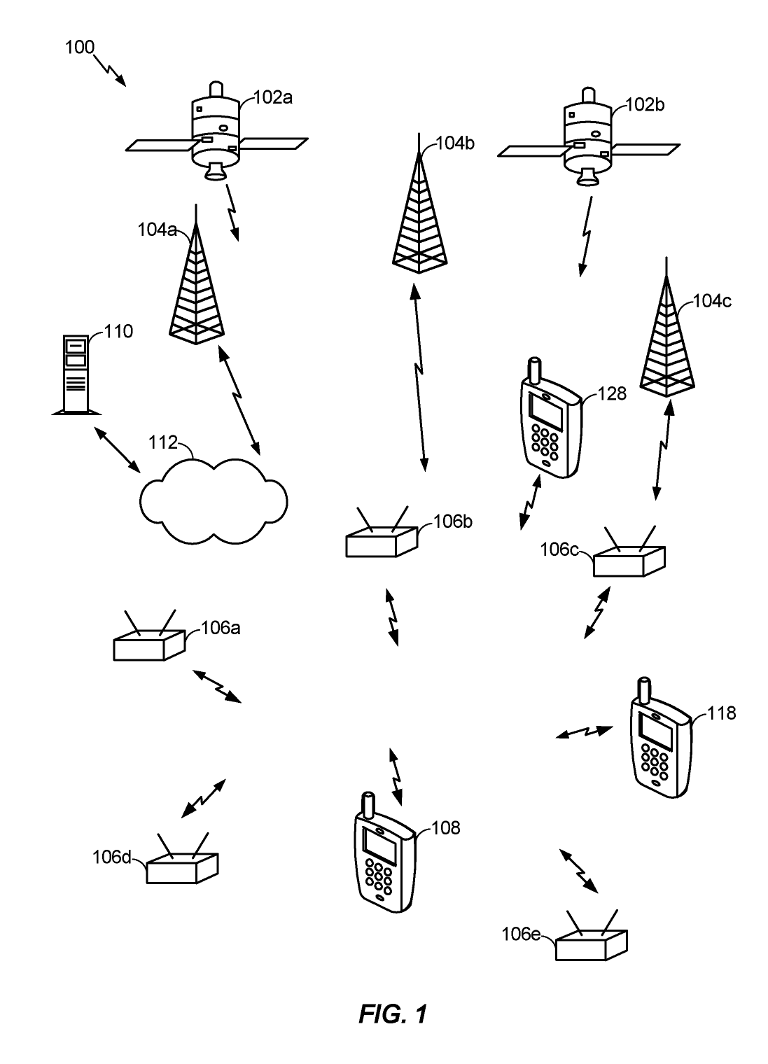

With reference to FIG. 1, shown is a schematic diagram of an example operating environment 100 that includes a wireless device (also referred to as a mobile wireless device or as a mobile station) 108 in communication with one or more wireless devices. The various wireless devices of FIG. 1 may be configured to communicate according to one or more communication protocols. As will be discussed in greater detail below, the various wireless devices of FIG. 1, including, the mobile device 108, may be configured, in some embodiments, to determine an adjustable timeout interval based on network characteristics associated with a network that includes two or more such communicating devices. For example, a first device (from the devices depicted in FIG. 1) may be configured to determine adjustable timeout periods for transmitting at least one subsequent wireless message (i.e., subsequent to an earlier wireless message, if the first device has not received an acknowledgement message from a second device, within the adjustable timeout period) based, for example, on time remaining in a session (network session) involving the first and second devices.

The mobile device 108 (as well as any other device depicted in FIG. 1) may be configured to operate and interact with multiple types of other communication systems/devices, including local area network devices (or nodes), such as WLAN for indoor communication, femtocells, Bluetooth® wireless technology-based transceivers, and other types of indoor communication network nodes, wide area wireless network nodes, satellite communication systems, other mobile devices (e.g., mobile devices 118 and 128 depicted in FIG. 1), etc., and as such the mobile device 108 may include one or more interfaces to communicate with the various types of communications systems. The various devices of FIG. 1 may be configured to establish and operate according to any number of communication protocols, including, for example, a long-term evolution positioning protocol (LPP) in which a location server, which may include a wireless communication module (e.g., a wireless transceiver), or which may be in communication with a wireless device, facilitates location determination for a first device.

As noted, the environment 100 may contain one or more different types of wireless communication systems or nodes. Such nodes include wireless access points (or WAPs) and may include LAN and/or WAN wireless transceivers, including, for example, WiFi base stations, femto cell transceivers, Bluetooth® wireless technology transceivers, cellular base stations, WiMax transceivers, etc. Thus, for example, and with continued reference to FIG. 1, the environment 100 may include the Local Area Network Wireless Access Points (LAN-WAPs) 106a-e that may be used for wireless voice and/or data communication with the mobile device 108. The LAN-WAPs 106a-e may also be utilized, in some embodiments, as independent sources of position data, e.g., through fingerprinting-based procedures, through implementation of multilateration-based procedures based, for example, on timing-based techniques (e.g., RTT-based measurements), signal strength measurements (e.g., RSSI measurements), etc. The LAN-WAPs 106a-e can be part of a Wireless Local Area Network (WLAN), which may operate in buildings and perform communications over smaller geographic regions than a WWAN. Additionally in some embodiments, the LAN-WAPs 106a-e could also include pico or femto cells. In some embodiments, the LAN-WAPs 106a-e may be part of, for example, WiFi networks (802.11x), cellular piconets and/or femtocells, Bluetooth® wireless technology Networks, etc. The LAN-WAPs 106a-e may, for example, include a Qualcomm indoor positioning system (QUIPS). A QUIPS or other like system implementation may, in some embodiments, be configured so that a mobile device may communicate with a server that provides the device with data (such as assistance data, e.g., floor plans, AP MAC IDs, RSSI maps, etc.) for a particular floor or some other region where the mobile device is located. Although five (5) LAN-WAP's are depicted in FIG. 1, any number of such LAN-WAP's may be used, and, in some embodiments, the environment 100 may include no LAN-WAPs access points at all, or may include a single LAN-WAP.

As further illustrated, the environment 100 may also include a plurality of one or more types of the Wide Area Network Wireless Access Points (WAN-WAPs) 104a-c, which may be used for wireless voice and/or data communication, and may also serve as another source of independent information through which the mobile wireless device 108 may determine its position/location. The WAN-WAPs 104a-c may be part of wide area wireless network (WWAN), which may include cellular base stations, and/or other wide area wireless systems, such as, for example, WiMAX (e.g., 802.16). A WWAN may include other known network components which are not shown in FIG. 1. Typically, each WAN-WAPs 104a-104c within the WWAN may operate from fixed positions or may be moveable, and may provide network coverage over large metropolitan and/or regional areas. Although three (3) WAN-WAPs are depicted in FIG. 1, any number of such WAN-WAPs may be used. In some embodiments, the environment 100 may include no WAN-WAPs at all, or may include a single WAN-WAP.

Communication to and from the mobile device 108 (to exchange data, provide location determination operations and services to the device 108, etc.) may be implemented, in some embodiments, using various wireless communication networks and/or technologies such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. In some embodiments, 4G networks, Long Term Evolution (“LTE”) networks, Advanced LTE networks, Ultra Mobile Broadband (UMB) networks, and all other types of cellular communications networks may also be implemented and used with the systems, methods, and other implementations described herein. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

In some embodiments, and as further depicted in FIG. 1, the mobile device 108 may also be configured to at least receive information from a Satellite Positioning System (SPS) 102a-b, which may be used as an independent source of position information for the mobile device 108. The mobile device 108 may thus include one or more dedicated SPS receivers configured to receive signals for deriving geo-location information from the SPS satellites. In embodiments in which the mobile device 108 can receive satellite signals, the mobile device may utilize a receiver (e.g., a GNSS receiver) specifically implemented for use with the SPS to extract position data from a plurality of signals transmitted by at least the SPS satellites 102a-b. Transmitted satellite signals may include, for example, signals marked with a repeating pseudo-random noise (PN) code of a set number of chips and may be located on ground based control stations, user equipment and/or space vehicles. The techniques provided herein may be applied to, or otherwise implemented, for use in various other systems, such as, e.g., Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that may be associated with, or otherwise enabled, for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals may include SPS, SPS-like, and/or other signals associated with such one or more SPS.

As further shown in FIG. 1, the system 100 may further include a server 110 (e.g., a location server, or any other type of server) configured to communicate, via a network 112 (e.g., a cellular wireless network, a WiFi network, a packet-based private or public network, such as the public Internet), or via wireless transceivers included with the server 110, with multiple network elements or nodes, and/or mobile wireless devices. For example, the server 110 may be configured to establish communication links with one or more of the WLAN nodes, such as the access points 106a-e, which may be part of the network 112, to communicate data and/or control signals to those access points, and receive data and/or control signals from the access points. Each of the access points 106a-e can, in turn, establish communication links with mobile devices located within range of the respective access points 106a-e. The server 110 may also be configured to establish communication links (directly via a wireless transceiver(s), or indirectly, via a network connection) with one or more of the WWAN nodes, such as the WWAN access points 104a-c depicted in FIG. 1, which may also be part of the network 112, and/or to establish communication links with one or more mobile wireless devices, such as any of the device 108, 118, and/or 128 of FIG. 1. The server 110 may also be configured to at least receive information from satellite vehicles 102a and/or 102b of a Satellite Positioning System (SPS), which may be used as an independent source of position information. In some embodiments, the server 110 may be part of, attached to, or reachable from network 112, and may communicate with the mobile wireless devices 108, 118, and/or 128, via the network 112.

In embodiments in which the server 110 is a location server, the location server may be an Evolved Serving Mobile Location Center (E-SMLC). In some implementations, the location server may communicate with a Mobility Management Entity (MME; not shown), configured to perform various control functions such as mobility management, gateway selection, authentication, bearer management, etc. Such an MME system may also be in communication with one or more of the wireless devices depicted in FIG. 1, either directly or via the network 112 and/or via any of the nodes/devices illustrated in FIG. 1. In some embodiments, an MME may also communicate with a Gateway Mobile Location Center (GMLC; also not shown) configured to perform various functions to support location services, interface with external location services (LCS) clients, and provide services such as subscriber privacy, authorization, authentication, billing, etc. A GMLC may include a Home GMLC (H-GMLC), a Visited GMLC (V-GMLC), and/or a Requesting GMLC (R-GMLC). An H-GMLC, V-GMLC, and R-GMLC are not illustrated in FIG. 1.

In some embodiments, the server 110 may implement such protocols as an LTE Positioning Protocol (LPP) and/or the LPP Extensions (LPPe) protocol for direct communication and to control and transfer measurements. The LPP protocol is defined by 3GPP, and the ULP and LPPe protocols are defined by the Open Mobile Alliance (OMA). Other communication protocols that may be implemented by the server 110 may include protocols as Secure User plane Location (SUPL), User plane Location Protocol (ULP), etc.

Thus, in some embodiments, the mobile device 108 may communicate with any one or a combination of the SPS satellites 102a-b, the WAN-WAPs 104a-c, the LAN-WAPs 106a-e, the server 110, and/or the mobile wireless devices 118 and 128. In some embodiments, each of the aforementioned systems can provide an independent information estimate of the position for the mobile device 108 using the same or different techniques. In some embodiments, the mobile device may combine the solutions derived from each of the different types of wireless devices to improve the accuracy of the position data. It is also possible to hybridize measurements from different systems to get a position estimate, particularly when there is an insufficient number of measurements from all individual systems or devices to derive a position. For instance, in an urban canyon setting, only one GNSS satellite may be visible and provide adequate measurements (i.e. raw pseudorange and Doppler observables). By itself, this single measurement cannot provide a position solution. However, it could be combined with measurements from urban WiFi APs, or WWAN cell ranges. When deriving a position using the access points 104a-c, 106a-e, the satellites 102a-b, and/or other wireless devices, at least some of the operations/processing may be performed using a server (e.g., a location server, such as the server 110), which may be accessed, in some embodiments, via a network 112.

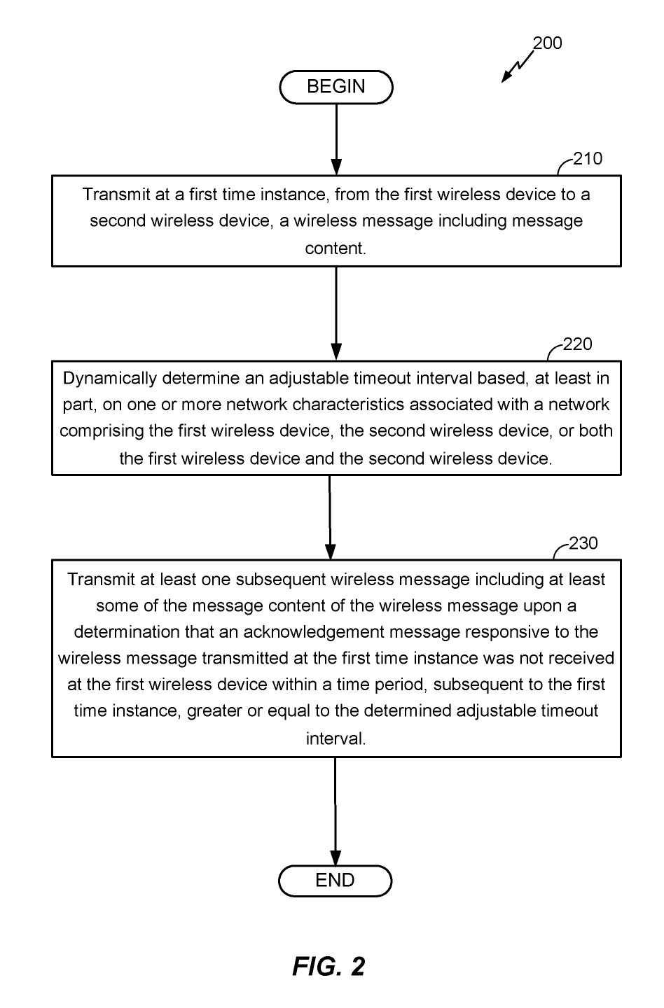

With reference to FIG. 2, a flowchart of an example procedure 200 to determine dynamically adjustable timeout intervals for re-transmitting a wireless message (e.g., transmitting at least one subsequent message with at least some of the message content of an earlier/preceding wireless message) from a first wireless device to a second wireless device is shown. The example procedure 200 includes, at block 210, transmitting at a first time instance, from the first wireless device to the second wireless device, a wireless message that includes message content, e.g., content of a positioning capability request message, content of a response to the positioning capability request, positioning assistance data, etc.) As noted, in some embodiments, the communication protocol under which the first and second device communicate may be a long term evolution (LTE) positioning protocol (LPP), and thus, in such embodiments, the wireless message transmitted by the first device may be an LPP message (e.g., transmitted to establish an LPP session, or transmitted during an already on-going LPP session). Generally, an LPP session is established between a Location Server (e.g., a server, such as the server 110) and a target device (e.g., the device for which location information is to be provided) in order to obtain location related measurements or a location estimate, or to transfer assistance data. As noted, the location server may communicate directly with the target device (e.g., via a local transmitter constituting part of the location server), or indirectly via a wireless node (e.g., any of the access points 104a-c or 106a-e, or via some other wireless or mobile device) with which the server communicates through a wired connection (including via a wired network path) or through a wireless connection.

Generally, an LPP transaction involves the exchange of one or more LPP messages between the location server and a target device. Each message type may contain information specific to one or more positioning processes or techniques and/or information common to all positioning processes or techniques. Each LPP message may carry an acknowledgment request and/or an acknowledgement indicator. An LPP wireless message that includes an acknowledgement request (i.e., includes the IE ackRequested set to TRUE) may also include a sequence number. Upon receipt of an LPP message which includes the IE ackRequested set to TRUE, a receiver may be configured to return an LPP message with an acknowledgement response, e.g., an acknowledgement that includes the ackIndicator IE set to the same sequence number of the message being acknowledged. An acknowledgment response may contain no LPP message body (in which case only the sequence number being acknowledged is significant). Alternatively, the acknowledgment may be sent in an LPP message along with an LPP message body. In some embodiments, an acknowledgment may be returned for each received LPP message including any duplicate. Once the first device (the sender device sending the message requiring an acknowledgement) receives an acknowledgment for an LPP message and determines (in some embodiments) that any included sequence number matches the sequence number transmitted with the originating message, the first device may send the next LPP message. In some embodiments, when the first and second wireless devices communicate according to the LPP protocol, the LPP messages communicated may include capability transfer messages (such as a positioning capability request message or a positioning capability response message in which the communicating devices can obtain or provide information about the capabilities and resources available to support a session, e.g., transferring UE positioning capability information to a location server such as an E-SMLC), positioning assistance messages (such as a positioning assistance data request message, a positioning assistance data delivery message, e.g., a positioning assistance data delivery from the E-SMLC to the UE), location information messages, session management messages to facilitate error handling and abort functions (e.g., service activation messages, service termination messages), etc.

In some embodiments, retransmission functionality (e.g., to transmit subsequent messages that are the same or similar as an unacknowledged message transmitted earlier), which builds on the acknowledgment and duplicate detection functionality, is implemented. For example, when an LPP message which requires acknowledgement is sent but is not acknowledged, the sending device may send a subsequent LPP message (with at least some of the content of the earlier LPP message) following a timeout period (this may be repeated a predetermined number of times, e.g., three (3) retransmission attempts, in some embodiments). If still unacknowledged after that, the sending device may terminate/abort all communication activity for the associated session. In some embodiments, a static retransmission timing procedure to control transmission timeout may be used. However, static timeout may hold-up the processing resources and may not allow other messages to be processed during the wait periods, which can lead to call flow failure if the devices do not abide by QoS provided in, for example, a request message (e.g., a location request message).

Accordingly, in implementations described herein, the first wireless device, e.g., the device which transmitted the unacknowledged wireless message, is configured to wait for an acknowledgement for the wireless message it transmitted (at a first time instance) before proceeding to transmit the next wireless message (e.g., to transmit another request under the LPP protocol). When an acknowledgement message is not received by the first wireless device, the first device is configured, in such embodiments, to transmit, following a timeout period/interval, a subsequent wireless message that may be the same or similar (e.g., substantially the same content, except, possibly, for control information, such as a timestamp, etc.) to the wireless message it transmitted at the first time instance. In some embodiments, retransmissions of the wireless message may be performed up to some threshold number of times, for example, in certain implementations three times (or some other pre-determined number of times). If the re-transmitted wireless message remains unacknowledged after that, the sender may conclude or abort all LPP activity for the associated session. As noted, if the timeout period (be it for an LPP message, or a message transmitted under some other protocol) is static, the static timeout period may hold up processing. Furthermore, a static timeout period may be too low or too high depending on the network characteristics associated with the sending device and/or the receiving device. For example, an established session between the first device and a location server (communicating with the first device via a second wireless device) may have an associated QoS that is relatively short, and thus, if a static retransmission timeout period for the first, sending, device is set to a relatively large value, fewer retransmission attempts may be realized than what is permissible under the protocol in use before the session expires (e.g., the QoS may be such that the session expires after only one retransmission attempt has been made, even though three, or more, retransmission attempts were otherwise allowed for the particular wireless message).

Thus, with continued reference to FIG. 2, in some implementations, the first device is configured to dynamically determine (at block 220 of FIG. 2) an adjustable timeout interval based, at least in part, on one or more network characteristics associated with a network comprising the first wireless device, the second wireless device, or both the first wireless device and the second wireless devices. As noted, in some embodiments, the determination of the adjustable timeout interval may be based on how much time remains before a current session involving the first and second wireless devices expires, and/or how many retransmission attempts (i.e., transmission attempts for a wireless message, with at least some of the content as an earlier, unacknowledged, wireless message transmitted in the subsequent transmission attempts) have already been made for the current wireless message for which the first wireless device is awaiting an acknowledgement. If only a relatively short period of time remains before a current session between the first device and the second device (which may or may not be coupled to a server to which the current wireless message is directed), and the current timeout interval is such that the current session would expired before all remaining available retransmission attempts have been used, the timeout interval may be adjusted so that all remaining retransmission attempts for the current wireless message may be utilized (if needed) prior to the expiration of the session. For example, consider a scenario in which there are three allowed (and, thus far, unused) retransmission attempts for a given wireless message, and that the retransmission timeout interval is set to a value of 8 milliseconds. Assume also that the current session is due to expire in 3 milliseconds (e.g., based on QoS for the current session). In this scenario, the adjustable timeout may be adjusted to 1 millisecond so that the first device may be able to re-retransmit (i.e., transmit subsequent messages with at least some of the content of the earlier unacknowledged wireless message) three times prior to expiry of the session. In some embodiments, the first device may be configured to set the timeout interval for all the available retransmission attempts to a constant value, and may do so in advance of performing the first retransmission (in some embodiments, the adjustable timeout interval may be determined prior to sending the underlying wireless message, e.g., prior to sending the wireless message at the block 210 of FIG. 2.

In some embodiments, the retransmission timeout interval may be periodically adjusted multiple times for a particular wireless message based, for example, on changing network conditions. For example, prior to attempting the first retransmission of a wireless message, the timeout period may be determined and set to a value that would allow three (3) retransmission attempts during the remaining period before the current session expires. Consider a situation where, subsequently, a determination is made that the current session has been shortened (e.g., because a change to the QoS) so that not all retransmission attempts could be utilized. Under these circumstances, the previously determined adjustable timeout interval/period for transmission of subsequent wireless messages may be dynamically re-computed to allow an earlier performance of the remaining transmission attempts than what was previously determined. Furthermore, the fact that network conditions are fluctuating may be taken into account to factor in the uncertainty associated with network conditions (e.g., to dynamically compute an even shorted retransmission timeout period than would be necessary to perform all remaining transmission attempts if the network conditions remained stable).

In some embodiments, dynamic determination of the adjustable timeout interval based on one or more network characteristics may include dynamically determining the adjustable timeout interval based on data comprising one or more of, for example, LTE real time reference signal received power (RSRP) value, reference signal received quality (RSRQ) information, a type of the wireless message (e.g., a type of an LPP message), etc. RSRP generally refers the linear average power of the resource elements that carry cell-specific signals across a channel bandwidth, while RSRQ generally refers to a value computed as RSRQ=N×RSRP/RSSI, where N is the number of Physical Resource Blocks (PRBs) over which the RSSI is measured and is usually equal to system bandwidth (RSSI, corresponding to received signal strength indicator, measures the received wide-band power by UE, including intracell power, interference and noise). When, for example, the RSRP level is relatively low (e.g., less than some predetermined RSRP threshold value), indicative of a possibly weak network transmission environment, the adjustable timeout interval(s) may be set to a relatively larger value (e.g., longer intervals between successive retransmissions of the wireless message) because of the expectation that it may be more difficult (and thus longer) for the wireless message transmitted by the first wireless device to be received and processed at the destination. For example, retransmission of an unacknowledged wireless message may be set to time instances at n, 2n, and 4n (from the time instance at which the current wireless message was first sent by the originating sender device, i.e., the first wireless device), where n may be an initial timeout value (e.g., provided in milliseconds) for the adjustable timeout interval. On the other hand, when the RSRP level is relatively high (e.g., higher than, or equal to, some predetermined RSRP threshold value), indicative of a relatively stronger (more favorable) network transmission environment, the adjustable timeout interval may be set to relatively shorter values (e.g., shorter intervals between successive transmissions of subsequent wireless messages with at least some of the message content of the wireless message) because the expectation is that it should be easier (and thus would require less time) to receive and process wireless messages received at the destination from the first wireless device. For example, retransmission of an unacknowledged wireless message may be set to time instances of n, n+1, and n+2 (values provided, for example, in millisecond). Thus, in some embodiments, dynamically determining the adjustable timeout interval may include determining an initial timeout value, n, with n provided in milliseconds, and in response to a determination that the initial timeout value, n, is less than a pre-determined threshold value, setting each of at least one subsequent time instance (to transmit respective at least one subsequent wireless message that each includes at least some of the content of the earlier unacknowledged message) according to: 1) a·k·n, when the RSRP value is less than a pre-determined RSRP threshold value, where a is a scaler value, and k=1, 2, 3, . . . , and is representative of a number of retransmission attempts, or 2) n+k·b, when the RSRP value is greater than or equal to the pre-determined RSRP threshold value, where b is a time value provided in milliseconds (e.g., 1 millisecond).

With continued reference to FIG. 2, having determined an adjustable timeout interval, at least one subsequent wireless message (that includes corresponding content based on the content of the wireless message transmitted at the first time instance, and may thus include at least some of the message content of the wireless message transmitted at the first time instance) is transmitted (at block 230) upon a determination that an acknowledgement message responsive to the wireless message transmitted at the first time instance was not received at the first wireless device within a time period, subsequent to the first time instance, greater or equal to the determined adjustable timeout interval. As noted, the adjustable timeout interval may include an actual value (e.g., in milliseconds or seconds) at the expiration of which (measured from the time instance the original wireless message was transmitted by the first device) at least some of the content of the wireless message transmitted at the first time instance is re-transmitted by the device (e.g., achieved through the at least one subsequent wireless message). Alternatively, as also noted, determination of the adjustable timeout interval may include computing and setting one or more subsequent time instances. In some embodiments, the adjustable timeout interval may be determined for each transmission or retransmission attempt. Thus, for example, following the original transmission of the wireless message, a determination of the adjustable timeout period (e.g., based on the current network characteristics at about the time the original transmission of the wireless message occurred) may be performed, and transmission of the at least one subsequent wireless message may then occur at a time instance corresponding to that computed adjustable timeout interval/period (assuming that no acknowledgement to the originally transmitted wireless message was received in the interim). Following this subsequent transmission, the adjustable timeout interval may again be re-computed (based on current network characteristics), and a further retransmission of at least some of the content of the originally transmitted wireless message (i.e., the one transmitted at the first time instance) may be performed at a next time instance corresponding to the re-computed adjustable timeout interval (again, assuming that no acknowledgement has been received for either the originally sent wireless message or for any subsequent wireless message). As also noted, in some embodiments, the retransmission of the wireless message may occur at time instances that have been determined based on network characteristics at a particular time. For example, in situations where three (3) retransmission attempts are allowed before expiration of a current session (e.g., for LPP-type communication messages), the time instances for the three retransmission attempts (i.e., three transmissions of subsequent wireless messages) may be set to n, 2n, 4n (or to some other multiples of n) when n (an initial timeout interval value) is small (e.g., less than a pre-determined threshold value) and RSRP value is less than a pre-determined RSRP threshold value.

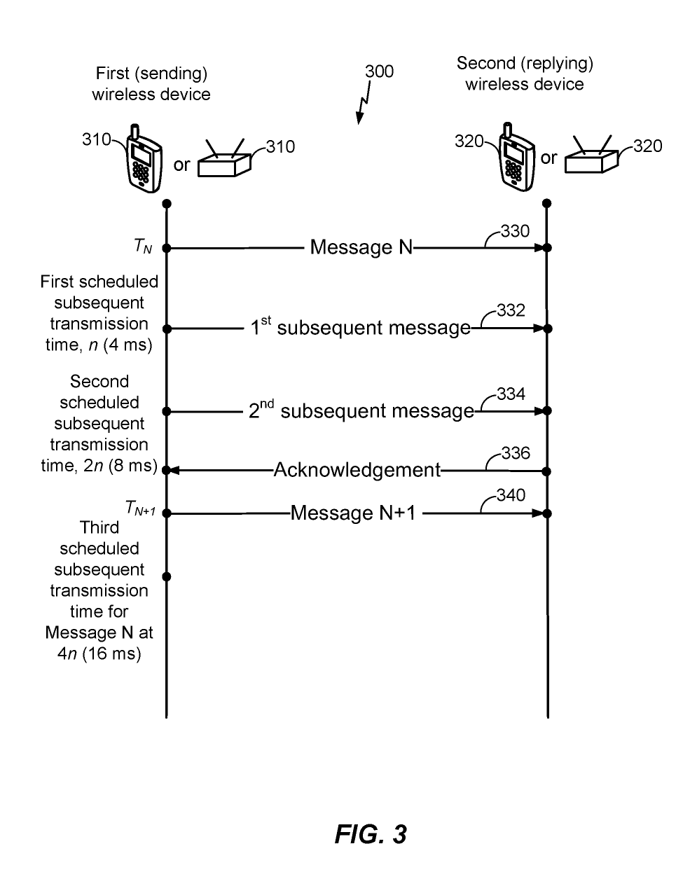

To further illustrate the processing performed to dynamically determine adjustable timeout intervals and retransmit unacknowledged wireless messages, reference is now made to FIG. 3 showing an example message flow exchange 300 between a first device 310 and a second device 320. As illustrated, a message 330 (denoted as Message N) is originally communicated, at a time instance marked as T_{N}, from the first device 310 to the second device 320. As shown, in some embodiments, the device 310 may be a wireless device such as the 108 of FIG. 1, and the second device 320 may be an access point, which communicates with a location server (which may be similar to the server 110 of FIG. 1) via a network 112 (the access point may itself be configured to implement the location server, or to implement some other server functionality). Alternatively, the first device (the sending device) may be an access point (or some other type of wireless device or node, such as a base station) in communication with a server such as a location server, and the second device may be a mobile wireless device (e.g., a personal wireless phone). In some embodiments, the devices 310 and/or 320 may be similar to any of the other nodes/devices depicted in FIG. 1. The devices 310 and/or 320 may be configured to communicate based, for example, on the LPP protocol, or based on some other communication protocol (e.g., an interactive communication protocol in which the two devices exchange messages and respond to messages from the device with which they are communicating). Where the first device is a mobile wireless device, the first device 310 may have initiated communication with the device 320 in order to receive location information (e.g., location information derived by a location server), to receive assistance data, or to otherwise receive a service provided by, or supported by, a server coupled to, or in communication with, the device 320. If the initiating device is a device coupled to the location server (or the location server itself has integrated wireless communication functionality), the device may have initiated the communication (e.g., under the LPP protocol) in order to, for example, request capability data from a mobile device (e.g., a UE) with which it is communicating, to request measurement data (e.g., signal strength, or data representative of signal strength, such as RSSI, RSRP, etc.), to transmit control signals or data, etc.

In the example of FIG. 3, the first, sending, wireless device 310 is configured to determine an adjustable timeout interval/period based on one or more network characteristics for a network that includes the first wireless device 310 and/or the second wireless device 320. For example, the adjustable timeout interval may be computed based on QoS associated with the present session between the first device 310 and the second device 320 (e.g., remaining QoS in hand). The adjustable timeout interval may thus be computed to achieve uniform, or non-uniform, subsequent transmission periods (also referred to as “retransmission periods”) to allow available subsequent transmission attempts to be performed. For example, in some embodiments, three subsequent attempts may be allowed for LPP protocol, and thus, the first device, or some other remote device in communication therewith, may determine a subsequent transmission schedule to allow all available subsequent transmission attempts prior to expiry of the current session between the first and second devices. As noted, in some embodiments, other network characteristics, such as derived RSRP values, RSRQ values, etc., may be used (separately, or in conjunction with QoS data) to determine the adjustable timeout interval (or to otherwise schedule the retransmission time instances at which retransmission is to be performed). As also noted, in some embodiments, the adjustable timeout interval may be computed prior to the initial transmission of the message 330 to the second device 320. Additionally and/or alternatively, an initially determined retransmission timeout interval may be periodically adjusted (during the session, e.g., after every transmission/retransmission attempt for the current wireless message) to thus continually adjust the timeout period (the subsequent transmission schedule) based on current network conditions in which the first and second device are communicating/interacting.

Assume that in the example of FIG. 3 network conditions/characteristics are such that measured RSRP is low (relative to some predetermined threshold value) and that an initial retransmission timeout interval, n, is relatively small (e.g., is equal, in this example, to 4 millisecond). Assume also that there are three available retransmission attempts, and that the session will not expire until 30 milliseconds from the initial transmission of the message 330. In this situation, the retransmission schedule may be computed to set the three subsequent transmission attempts at n, 2n, and 4n (from the time instance, T_{N}, at which the wireless message 330 was first sent), and therefore, three retransmission attempts are scheduled at 4 milliseconds, 8 millisecond, and 16 milliseconds (other formulations for the scheduling of retransmission attempts, for these particular network conditions/characteristics, may of course be used).

As further shown in the example of FIG. 3, at the first retransmission (subsequent transmission) time instance (i.e., at the expiration of the timeout interval corresponding to the initial transmission of the message 330), no acknowledgement message has been received in response to the sending of the message 330. Accordingly, the first device 310 sends a subsequent transmission of a subsequent message (depicted as a 1^{st} subsequent wireless message 332) that includes at least some of the content of the message N. The first device 310 may be configured to re-compute the adjustable timeout period (or the retransmission schedule) based on current network conditions, or it may proceed with the already computed adjustable timeout interval or the re-transmission schedule. In this example, the first device continues with the already determined/computed schedule, and thus, when it is determined that no acknowledgement has been received in response to the 1^{st} subsequent wireless message 332 by the next scheduled subsequent transmission time instance (at 8 milliseconds from the original time instance at which the wireless message 330 was transmitted), the second subsequent attempt (retransmission) of at least some of content of the message N (via the 2^{nd} subsequent wireless message 334) is performed.

As further illustrated, prior to the third scheduled subsequent transmission time instance (at 16 milliseconds from the original time that the wireless message N was first transmitted), an acknowledgement message 336, to the 2^{nd} subsequent wireless message 334, is received by the first device 310 from the second device 320. Accordingly, the first device 310 may proceed to transmit the next wireless message (if there is one), i.e., a message that is not merely a retransmission attempt of the content of the wireless message 330, and thus, at a time T_{N+1}, the first device transmits the wireless message 340 (denoted as Message N+1).

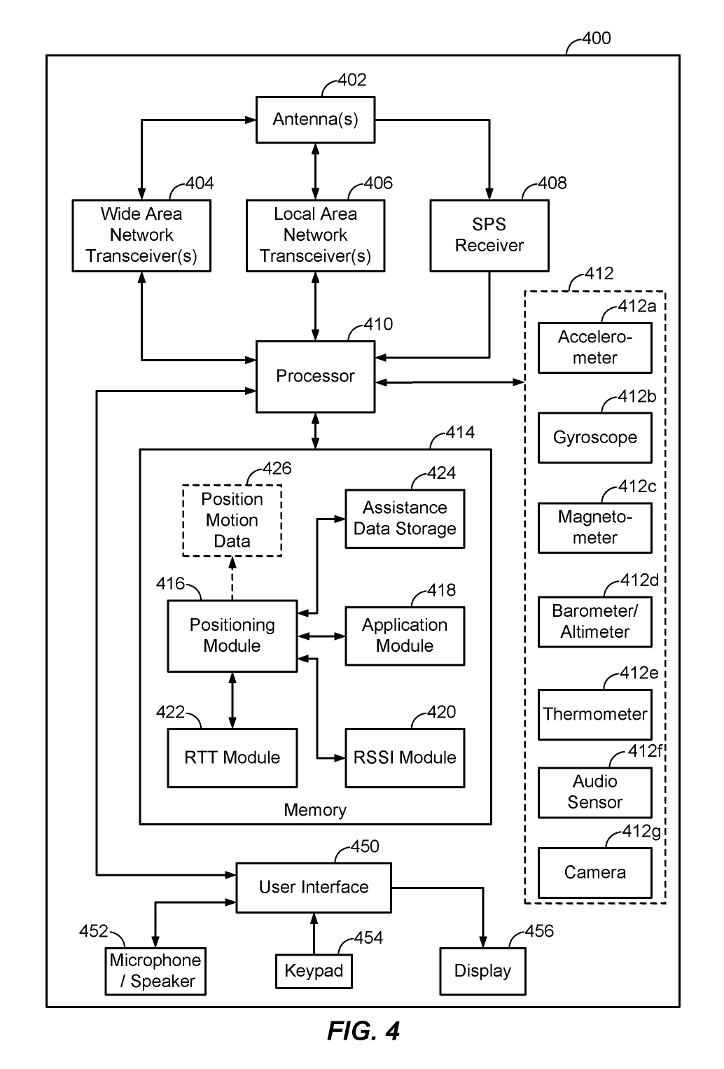

With reference now to FIG. 4, a schematic diagram illustrating various components of an example wireless device 400 (e.g., a mobile device), which may be similar to or the same as the wireless devices 108, 310, and/or 320 depicted in FIGS. 1 and 3, is shown. For the sake of simplicity, the various features/components/functions illustrated in the schematic boxes of FIG. 4 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 4 may be further subdivided, or two or more of the features or functions illustrated in FIG. 4 may be combined. Additionally, one or more of the features or functions illustrated in FIG. 4 may be excluded. In some embodiments, some or all of the components depicted in FIG. 4 may also be used in implementations of one or more of the wireless devices 106a-e and/or 104a-c, and/or the server 110 illustrated in FIG. 1. In such embodiments, the components depicted in FIG. 4 may be configured to cause the operations performed by devices (wireless devices, servers, such as location servers, etc.) as described herein (e.g., to transmit a wireless communication message, such as LPP message, dynamically determine adjustable subsequent transmission timeout intervals or subsequent transmission (retransmission) schedule, and transmit at least one subsequent wireless message with at least some of the content of the earlier transmitted wireless message if no acknowledgement is received by the end of the determined adjustable timeout interval).

As shown, the wireless device 400 may include one or more local area network transceivers 406 that may be connected to one or more antennas 402. The one or more local area network transceivers 406 comprise suitable devices, circuits, hardware, and/or software for communicating with and/or detecting signals to/from one or more of the WLAN access points 106a-e depicted in FIG. 1, and/or directly with other wireless devices (e.g., mobile devices) within a network. In some embodiments, the local area network transceiver(s) 406 may comprise a WiFi (802.11x) communication transceiver suitable for communicating with one or more wireless access points; however, in some embodiments, the local area network transceiver(s) 406 may be configured to communicate with other types of local area networks, personal area networks (e.g., Bluetooth® wireless technology networks), etc. Additionally, any other type of wireless networking technologies may be used, for example, Ultra Wide Band, ZigBee, wireless USB, etc.

The wireless device 400 may also include, in some implementations, one or more wide area network transceiver(s) 404 that may be connected to the one or more antennas 402. The wide area network transceiver 404 may comprise suitable devices, circuits, hardware, and/or software for communicating with and/or detecting signals from one or more of, for example, the WWAN access points 104a-c illustrated in FIG. 1, and/or directly with other wireless devices within a network. In some implementations, the wide area network transceiver(s) 404 may comprise a CDMA communication system suitable for communicating with a CDMA network of wireless base stations. In some implementations, the wireless communication system may comprise other types of cellular telephony networks, such as, for example, TDMA, GSM, WCDMA, LTE, etc. Additionally, any other type of wireless networking technologies may be used, including, for example, WiMax (802.16), etc.

In some embodiments, an SPS receiver (also referred to as a global navigation satellite system (GNSS) receiver) 408 may also be included with the wireless device 400. The SPS receiver 408 may be connected to the one or more antennas 402 for receiving satellite signals. The SPS receiver 408 may comprise any suitable hardware and/or software for receiving and processing SPS signals. The SPS receiver 408 may request information as appropriate from the other systems, and may perform the computations necessary to determine the position of the mobile device 400 using, in part, measurements obtained by any suitable SPS procedure. Additionally, measurement values for received satellite signals may be communicated to a location server configured to facilitate location determination.

As further illustrated in FIG. 4, the example wireless device 400 includes one or more sensors 412 coupled to a processor/controller 410. For example, the sensors 412 may include motion sensors to provide relative movement and/or orientation information (which is independent of motion data derived from signals received by the wide area network transceiver(s) 404, the local area network transceiver(s) 406, and/or the SPS receiver 408). By way of example but not limitation, the motion sensors may include an accelerometer 412a, a gyroscope 412b, and a geomagnetic (magnetometer) sensor 412c (e.g., a compass), any of which may be implemented based on micro-electro-mechanical-system (MEMS), or based on some other technology. The one or more sensors 412 may further include an altimeter (e.g., a barometric pressure altimeter) 412d, a thermometer (e.g., a thermistor) 412e, an audio sensor 412f (e.g., a microphone) and/or other sensors. The output of the one or more sensors 412 may be provided as data transmitted to a remote device or server (via the transceivers 404 and/or 406, or via some network port or interface of the device 400) for storage or further processing. As further shown in FIG. 4, in some embodiments, the one or more sensors 412 may also include a camera 412g (e.g., a charge-couple device (CCD)-type camera, a CMOS-based image sensor, etc.), which may produce still or moving images (e.g., a video sequence) that may be displayed on a user interface device, such as a display or a screen, and that may be further used to determine an ambient level of illumination and/or information related to colors and existence and levels of UV and/or infra-red illumination.

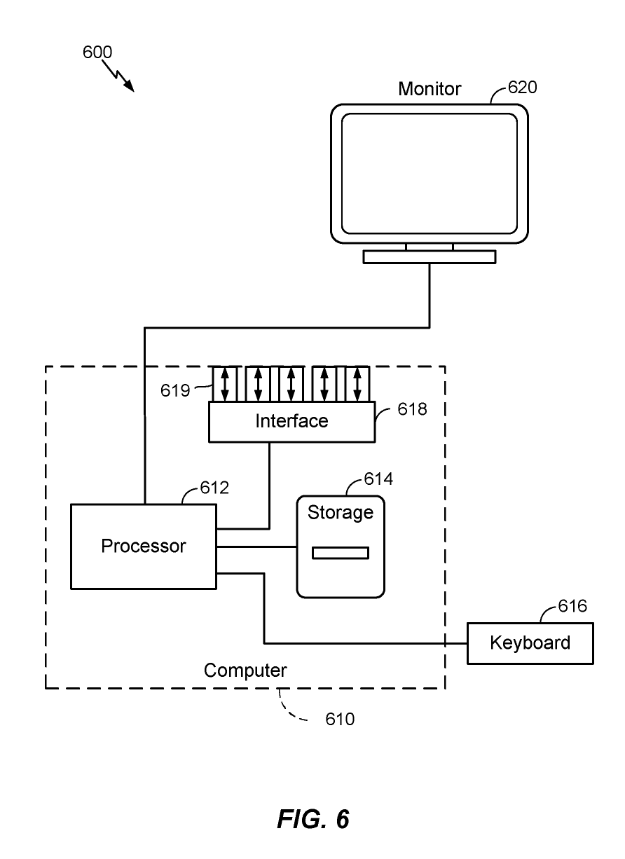

The processor(s) (also referred to as a controller) 410 may be connected to the local area network transceiver(s) 406, the wide area network transceiver(s) 404, the SPS receiver 408 and the one or more sensors 412. The processor may include one or more microprocessors, microcontrollers, and/or digital signal processors that provide processing functions, as well as other calculation and control functionality. The processor 410 may be coupled to storage media (e.g., memory) 414 for storing data and software instructions for executing programmed functionality within the mobile device. The memory 414 may be on-board the processor 410 (e.g., within the same IC package), and/or the memory may be external memory to the processor and functionally coupled over a data bus. Further details regarding an example embodiment of a processor or computation system, which may be similar to the processor 410, are provided below in relation to FIG. 6.

A number of software modules and data tables may reside in memory 414 and may be utilized by the processor 410 in order to manage both communications with remote devices/nodes (such as the various nodes and/or the server 110 depicted in FIG. 1), perform positioning determination functionality, and/or perform device control functionality. As illustrated in FIG. 4, in some embodiments, the memory 414 may include a positioning module 416, an application module 418, a received signal strength indicator (RSSI) module 420 (which may also be used to facilitate determination of network characteristics or values representative of network conditions, such as RSRP and/or RSRQ), and/or a round trip time (RTT) module 422. It is to be noted that the functionality of the modules and/or data structures may be combined, separated, and/or be structured in different ways depending upon the implementation of the mobile device 400. For example, the RSSI module 420 and/or the RTT module 422 may each be realized, at least partially, as a hardware-based implementation, and may thus include such devices or circuits as a dedicated antenna (e.g., a dedicated RTT and/or an RSSI antenna), a dedicated processing unit to process and analyze signals received and/or transmitted via the antenna(s) (e.g., to determine signal strength of received signals, determine timing information in relation to an RTT cycle, etc.)

The application module 418 may be a process running on the processor 410 of the mobile device 400, which requests position information from the positioning module 416, or which receives positioning/location data from a remote device (e.g., a remote location server). Applications typically run within an upper layer of the software architectures, and may include indoor navigation applications, shopping applications, location aware service applications, etc. The positioning module/circuit 416 may derive the position of the wireless device 400 using information derived from various receivers and modules of the mobile device 400, e.g., based on measurements performed by the RSSI module and/or the RTT module. Data derived by the positioning module 416 may be used to supplement location information provided, for example, by a remote device (such as a location server) or may be used in place of location data sent by a remoted device. For example, positioning module 416 may determine position of the device 400 based on measurements performed by various sensors, circuits, and/or modules of the device 400, and use those measurements in conjunction with assistance data received from a remote server to determine location of the device 400. The memory 414 may also include a module(s) to implement the processes described herein, e.g., the process to dynamically determine adjustable timeout intervals, and to transmit subsequent wireless messages with corresponding subsequent content based on the message content of the original, earlier, wireless message. For example, subsequent wireless messages may include substantially the same content as that of the original wireless message, except, possibly, control information, such as a timestamp, etc. Alternatively, the processes described herein may be implemented through the application module 418.

As further illustrated, the wireless device 400 may also include assistance data storage 424, where assistance data (which may have been downloaded from a remote server), such as map information, data records relating to location information in an area where the device is currently located, heatmaps (e.g., indicative of expected signal strength values, for signals transmitted from one or more wireless device, at various locations), etc., is stored. In some embodiments, the wireless device 400 may also be configured to receive supplemental information that includes auxiliary position and/or motion data which may be determined from other sources (e.g., from the one or more sensors 412). Such auxiliary position data may be incomplete or noisy, but may be useful as another source of independent information for estimating the position of the device 400, or for performing other operations or functions. Supplemental information may also include, but not be limited to, information that can be derived or based upon Bluetooth signals, beacons, RFID tags, and/or information derived from a map (e.g., receiving coordinates from a digital representation of a geographical map by, for example, a user interacting with a digital map). The supplemental information may optionally be stored in the storage module 426 schematically depicted in FIG. 4.

The wireless device 400 may further include a user interface 450 providing suitable interface systems, such as a microphone/speaker 452, a keypad 454, and a display 456 that allows user interaction with the device 400. The microphone/speaker 452 (which may be the same or different from the sensor 412f) provides for voice communication services (e.g., using the wide area network transceiver(s) 404 and/or the local area network transceiver(s) 406). The keypad 454 may comprise suitable buttons for user input. The display 456 may include a suitable display, such as, for example, a backlit LCD display, and may further include a touch screen display for additional user input modes.

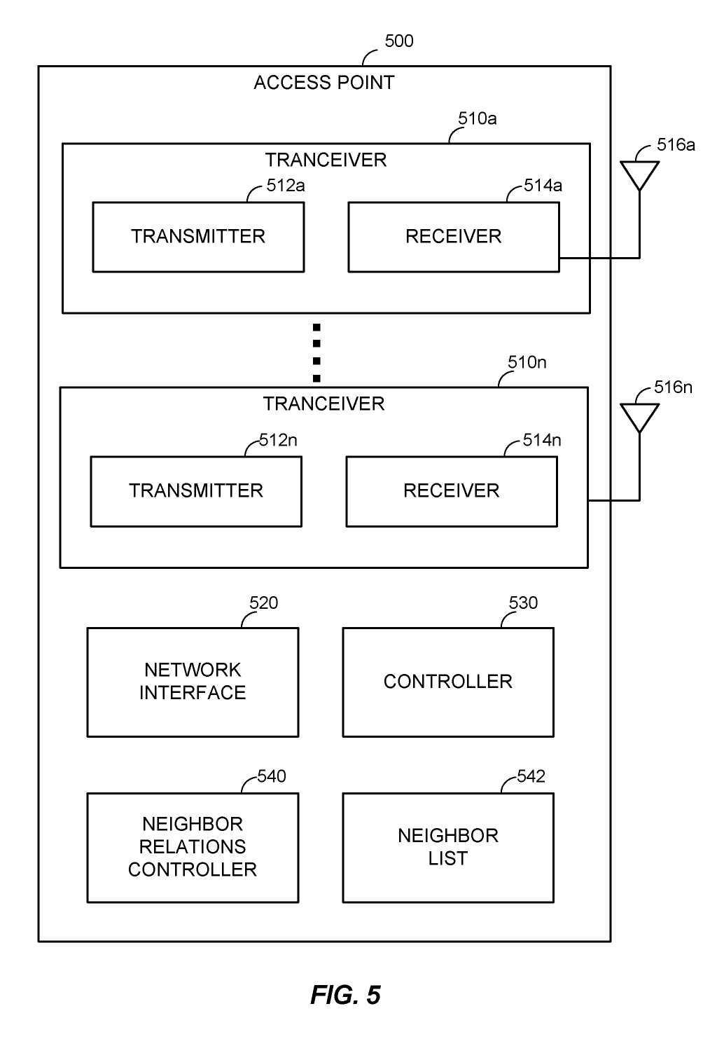

With reference now to FIG. 5, a schematic diagram of an example wireless node 500, such as access point (e.g., a base station), which may be similar to, and be configured to have a functionality similar to that, of any of the various nodes depicted in FIG. 1 (e.g., the nodes 104a-c, 106a-e, and/or the server 110), or the devices illustrated in FIG. 3, is shown. The node 500 may include one or more transceivers 510a-n electrically coupled to one more antennas 516a-n for communicating with wireless devices, such as, for example, the mobile devices 108, 310, 320, or 400 of FIGS. 1, 3 and 4, respectively. The each of the transceivers 510a-510n may include a respective transmitter 512a-n for sending signals (e.g., downlink messages) and a respective receiver 514a-n for receiving signals (e.g., uplink messages). The node 500 may also include a network interface 520 to communicate with other network nodes (e.g., sending and receiving queries and responses). For example, each network element may be configured to communicate (e.g., wired or wireless backhaul communication) with a gateway, or other suitable device of a network, to facilitate communication with one or more core network nodes (e.g., any of the other access points shown in FIG. 1, the server 110, and/or other network devices or nodes). Additionally and/or alternatively, communication with other network nodes may also be performed using the transceivers 510a-n and/or the respective antennas 516a-n.

The node 500 may also include other components that may be used with embodiments described herein. For example, the node 500 may include, in some embodiments, a controller 530 (which may be similar to the processor 410 of FIG. 4) to manage communications with other nodes (e.g., sending and receiving messages) and to provide other related functionality. For example, the controller 530 may be configured to control the operation of the antennas 516a-n so as to adjustably control the antennas' transmission power and phase, gain pattern, antenna direction (e.g., the direction at which a resultant radiation beam from the antennas 516a-n propagates), antenna diversity, and other adjustable antenna parameters for the antennas 516a-n of the node 500. In some embodiments, the antennas' configuration may be controlled according to pre-stored configuration data provided at the time of manufacture or deployment of the node 500, or according to data obtain from a remote device (such as a central server sending data representative of the antenna configuration, and other operational parameters, that are to be used for the node 500).

In some embodiments, the node 500 may also be configured to transmit wireless messages implemented under one or more communication protocols (e.g., LPP), to dynamically determine/derive an adjustable timeout interval (e.g., determine an actual timeout value, or a subsequent transmission/retransmission schedule relative to an instance in which an initial/original wireless message was sent), and to transmit at least one subsequent wireless message with content based on (e.g., substantially similar) to the message content of the original, earlier, transmitted wireless message, in accordance with the adjustable timeout interval (or in accordance with the derived subsequent transmission /retransmission schedule) when an acknowledgement to the wireless message fails to be received prior to the expiration of the timeout period or by the next scheduled retransmission time instance. As noted, in such embodiments, the node may send an initial wireless message (e.g., under the LPP protocol), such as a request message, in order to, for example, obtain capability data from a mobile device with which the node 500 may be communicating, to request measurement data, to transmit control signals or data, etc. The node 500 may also be configured, in some implementations, to perform location data services, or performs other types of services, for multiple wireless devices (clients) communicating with the node 500 (or communicating with a server coupled to the node 500), and to provide location data and/or assistance data to such multiple wireless devices.

In addition, the node 500 may include, in some embodiments, neighbor relations controllers (e.g., neighbor discovery modules) 540 to manage neighbor relations (e.g., maintaining a neighbor list 542) and to provide other related functionality. The controller 530 may be implemented, in some embodiments, as a processor-based device, with a configuration and functionality similar to that shown and described in relation to FIG. 6. In some embodiments, the node may also include one or more sensors (not shown), such as any of the one or more sensors 412 of the wireless device 400 depicted in FIG. 4.

Performing the procedures described herein may also be facilitated by a processor-based computing system. With reference to FIG. 6, a schematic diagram of an example computing system 600 is shown. The computing system 600 may be housed in, for example, a wireless device such as the devices 108, 310, 320 and 400 of FIGS. 1, 3, and 4, and/or may comprise at least part of, or all of, wireless devices, servers, nodes, access points, or base stations, such as the nodes 104a-b, 106a-c, 310, 320, and 500 depicted in FIGS. 1, 3, and 5. The computing system 600 includes a computing-based device 610 such as a personal computer, a specialized computing device, a controller, and so forth, that typically includes a central processor unit (CPU) 612. In addition to the CPU 612, the system includes main memory, cache memory and bus interface circuits (not shown). The computing-based device 610 may include a mass storage device 614, such as a hard drive and/or a flash drive associated with the computer system. The computing system 600 may further include a keyboard, or keypad, 616, and a monitor 620, e.g., a CRT (cathode ray tube), LCD (liquid crystal display) monitor, etc., that may be placed where a user can access them (e.g., a mobile device's screen).

The computing-based device 610 is configured to facilitate, for example, the implementation of one or more of the processes/procedures described herein, including the procedures to retransmit unacknowledged wireless messages (e.g., transmit subsequent messages with content based on the content of the unacknowledged wireless messages) according to adjustable timeout intervals dynamically determined based on one or more network characteristics. The mass storage device 614 may thus include a computer program product that, when executed on the computing-based device 610, causes the computing-based device to perform operations to facilitate the implementation of the procedures described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. For example, as illustrated in FIG. 6, the computing-based device 610 may include an interface 618 with one or more interfacing circuits (e.g., a wireless port that include transceiver circuitry, a network port with circuitry to interface with one or more network device, etc.) to provide/implement communication with remote devices (e.g., so that a wireless device, such as any of the wireless devices or nodes depicted in any of the figures, could communicate, via a port, such as the port 619, with another device or node). Alternatively and/or additionally, in some embodiments, special purpose logic circuitry, e.g., an FPGA (field programmable gate array), a DSP processor, an ASIC (application-specific integrated circuit), or other types of circuit-based and hardware arrangements may be used in the implementation of the computing system 600. Other modules that may be included with the computing-based device 610 are speakers, a sound card, a pointing device, e.g., a mouse or a trackball, by which the user can provide input to the computing system 600. The computing-based device 610 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device 610 or external to the device. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically (e.g., with lasers). Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising, at a first processor-based wireless device:
transmitting at a first time instance, from the first wireless device to a second wireless device, a wireless message including message content;
dynamically determining an adjustable timeout interval based, at least in part, on one or more network characteristics associated with a network comprising the first wireless device, the second wireless device, or both the first wireless device and the second wireless device; and
transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

2. The method of claim 1, wherein the wireless message comprises a long-term evolution positioning protocol (LPP) message.

3. The method of claim 2, wherein the LPP message includes: a positioning capability request message, a positioning capability response message, a positioning assistance data request message, a positioning assistance data delivery message, a location information transfer message, a session management message, or some combination thereof.

4. The method of claim 1, wherein dynamically determining the adjustable timeout interval based, at least in part, on the one or more network characteristics associated with the network comprises:
dynamically determining the adjustable timeout interval based on data indicative of: a long-term evolution (LTE) real time reference signal received power (RSRP) value, reference signal received quality (RSRQ) information, a type of the wireless message, or any combination thereof.

5. The method of claim 4, wherein dynamically determining the adjustable timeout interval comprises:
determining an initial timeout value, n, with n provided in milliseconds; and
in response to a determination that the initial timeout value, n, is less than a pre-determined threshold value, setting each of at least one subsequent time instance to transmit the at least one subsequent wireless message according to:
a·k·n, when the RSRP value is less than a pre-determined RSRP threshold value, where a is a scaler value, and k=1, 2, 3, . . . , and is representative of a number of subsequent transmission attempts; or
n+k·b, when the RSRP value is greater than or equal to the pre-determined RSRP threshold value, where b is a time value provided in milliseconds.

6. The method of claim 1, wherein the first wireless device comprises a mobile device and the second wireless device comprises a base station in communication with the mobile device.

7. The method of claim 1, wherein the first wireless device comprises a base station configured to receive acknowledgement signals transmitted by receiving devices in response to respective wireless messages transmitted by the base station, and wherein the second wireless device comprises a mobile device in communication with the base station.

8. The method of claim 7, wherein the base station configured to receive the acknowledgement signals is configured to communicate with a location server and to receive long-term evolution positioning protocol (LPP) acknowledgement messages transmitted by the receiving devices.

9. The method of claim 1, wherein dynamically determining the adjustable timeout interval comprises:
dynamically determining the adjustable timeout interval based on one or more quality of service (QoS) parameters for the first wireless device.

10. The method of claim 1, wherein dynamically determining the adjustable timeout interval comprises:
dynamically determining at least one subsequent time instance at which the at least one subsequent wireless message is to be transmitted, the at least one subsequent time instance determined based, at least in part, on time remaining before a current session between the first wireless device and the second wireless device is concluded.

11. A wireless device comprising:
one or more processors configured to:
dynamically determine an adjustable timeout interval based, at least in part, on one or more network characteristics associated with a network comprising the wireless device, another wireless device, or both the wireless device and the other wireless device;
at least one transceiver, coupled to the one or more processors, configured to:
transmit at a first time instance, from the wireless device to the other wireless device, a wireless message including message content; and
transmit at least one subsequent wireless message including at least some of the message content of the wireless message upon a determination that an acknowledgement message responsive to the wireless message transmitted at the first time instance was not received at the wireless device within a time period, subsequent to the first time instance, greater or equal to the determined adjustable timeout interval.

12. The wireless device of claim 11, wherein the wireless message comprises a long-term evolution positioning protocol (LPP) message.

13. The wireless device of claim 11, wherein the one or more processors configured to dynamically determine the adjustable timeout interval based, at least in part, on the one or more network characteristics associated with the network, are configured to:
dynamically determine the adjustable timeout interval based on data indicative of:
a long-term evolution (LTE) real time reference signal received power (RSRP) value, reference signal received quality (RSRQ) information, a type of the wireless message, or any combination thereof.

14. The wireless device of claim 13, wherein the one or more processors configured to dynamically determine the adjustable timeout interval are configured to:
determine an initial timeout value, n, with n provided in milliseconds; and
in response to a determination that the initial timeout value, n, is less than a pre-determined threshold value, set each of at least one subsequent time instance to transmit the at least one subsequent wireless message according to:
a·k·n, when the RSRP value is less than a pre-determined RSRP threshold value, where a is a scaler value, and k=1, 2, 3, . . . , and is representative of a number of subsequent transmission attempts; or
n+k·b, when the RSRP value is greater than or equal to the pre-determined RSRP threshold value, where b is a time value provided in milliseconds.

15. The wireless device of claim 11, wherein the wireless device comprises a base station configured to receive acknowledgement signals transmitted by receiving devices in response to respective wireless messages transmitted by the base station, and wherein the other wireless device comprises a mobile device in communication with the base station.

16. The wireless device of claim 11, wherein the one or more processors configured to dynamically determine the adjustable timeout interval are configured to:
dynamically determine the adjustable timeout interval based on one or more quality of service (QoS) parameters for the wireless device.

17. The wireless device of claim 11, wherein the one or more processors configured to dynamically determine the adjustable timeout interval are configured to:
dynamically determine at least one subsequent time instance at which the at least one subsequent wireless message is to be transmitted, the at least one subsequent time instance determined based, at least in part, on time remaining before a current session between the wireless device and the other wireless device is concluded.

18. An apparatus comprising:
means for transmitting at a first time instance, from a first wireless device to a second wireless device, a wireless message including message content;
means for dynamically determining an adjustable timeout interval based, at least in part, on one or more network characteristics associated with a network comprising the first wireless device, the second wireless device, or both the first wireless device and the second wireless device; and
means for transmitting at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

19. The apparatus of claim 18, wherein the wireless message comprises a long-term evolution positioning protocol (LPP) message.

20. The apparatus of claim 18, wherein the means for dynamically determining the adjustable timeout interval based, at least in part, on the one or more network characteristics associated with the network comprises:
means for dynamically determining the adjustable timeout interval based on data indicative of: a long-term evolution (LTE) real time reference signal received power (RSRP) value, reference signal received quality (RSRQ) information, a type of the wireless message, or any combination thereof.

21. The apparatus of claim 20, wherein the means for dynamically determining the adjustable timeout interval comprises:
means for determining an initial timeout value, n, with n provided in milliseconds; and
means setting each of at least one subsequent time instance to transmit the at least one subsequent wireless message, in response to a determination that the initial timeout value, n, is less than a pre-determined threshold value, according to:
a·k·n, when the RSRP value is less than a pre-determined RSRP threshold value, where a is a scaler value, and k =1, 2, 3, . . . , and is representative of a number of subsequent transmission attempts; or
n+k·b, when the RSRP value is greater than or equal to the pre-determined RSRP threshold value, where b is a time value provided in milliseconds.

22. The apparatus of claim 18, wherein the first wireless device comprises a base station configured to receive acknowledgement signals transmitted by receiving devices in response to respective wireless messages transmitted by the base station, and wherein the second wireless device comprises a mobile device in communication with the base station.

23. The apparatus of claim 18, wherein the means for dynamically determining the adjustable timeout interval comprises:
means for dynamically determining the adjustable timeout interval based on one or more quality of service (QoS) parameters for the first wireless device.

24. The apparatus of claim 18, wherein the means for dynamically determining the adjustable timeout interval comprises:
means for dynamically determining at least one subsequent time instance at which the at least one subsequent wireless message is to be transmitted, the at least one subsequent time instance determined based, at least in part, on time remaining before a current session between the first wireless device and the second wireless device is concluded.

25. A non-transitory computer readable media programmed with instructions, executable on a processor, to:
transmit at a first time instance, from a first wireless device to a second wireless device, a wireless message including message content;
dynamically determine an adjustable timeout interval based, at least in part, on one or more network characteristics associated with a network comprising the first wireless device, the second wireless device, or both the first wireless device and the second wireless device; and
transmit at least one subsequent wireless message including at least some of the message content of the wireless message upon a determination that an acknowledgement message responsive to the wireless message transmitted at the first time instance was not received at the first wireless device within a time period, subsequent to the first time instance, greater or equal to the determined adjustable timeout interval.

26. The computer readable media of claim 25, wherein the wireless message comprises a long-term evolution positioning protocol (LPP) message.

27. The computer readable media of claim 25, wherein the instructions to dynamically determine the adjustable timeout interval based, at least in part, on the one or more network characteristics associated with the network comprise one or more instructions to:
dynamically determine the adjustable timeout interval based on data indicative of: a long-term evolution (LTE) real time reference signal received power (RSRP) value, reference signal received quality (RSRQ) information, a type of the wireless message, or any combination thereof.

28. The computer readable media of claim 27, wherein the one or more instructions to dynamically determine the adjustable timeout interval comprise further one or more instructions to:
determine an initial timeout value, n, with n provided in milliseconds; and
in response to a determination that the initial timeout value, n, is less than a pre-determined threshold value, set each of at least one subsequent time instance to transmit the at least one subsequent wireless message according to:
a·k·n, when the RSRP value is less than a pre-determined RSRP threshold value, where a is a scaler value, and k=1, 2, 3, . . . , and is representative of a number of subsequent transmission attempts; or
n+k·b, when the RSRP value is greater than or equal to the pre-determined RSRP threshold value, where b is a time value provided in milliseconds.

29. The computer readable media of claim 25, wherein the instructions to dynamically determine the adjustable timeout interval comprise one or more instructions to:
dynamically determine the adjustable timeout interval based on one or more quality of service (QoS) parameters for the first wireless device.

30. The computer readable media of claim 25, wherein the instructions to dynamically determine the adjustable timeout interval comprise one or more instructions to:
dynamically determine at least one subsequent time instance at which the at least one subsequent wireless message is to be transmitted, the at least one subsequent time instance determined based, at least in part, on time remaining before a current session between the first wireless device and the second wireless device is concluded.
